(19) United States
(12) Patent Application Publication
(10) Pub. No.: US 2006/0031335 A1
(43) Pub. Date: Feb. 9, 2006

(54) Managing contained e-mail

(75) Inventor: James Edward Carey, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/911,848

(22) Filed: Aug. 5, 2004

(51) Int. Cl. G06F 15/16

(52) U.S. Cl. 709/206

(57) ABSTRACT

A method, apparatus, system, and signal-bearing medium that, in an embodiment, provide status and commands for manipulating contained-messages. A received e-mail message may contain the contained-messages, e.g., forwarded or replied-to messages, either embedded in the received e-mail message or as an attachment. The status may relate to not only the contained-message, but also may relate to another version of the contained-message that was previously received separately from the e-mail message that contains the contained-message. Commands may be directed to the received e-mail and its contained-messages, the contained-messages, and the version of the contained-messages that were separately received.

### FIELD

An embodiment of the invention generally relates to electronic mail. In particular, an embodiment of the invention generally relates to managing contained e-mail.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware components (such as semiconductors, integrated circuits, programmable logic devices, programmable gate arrays, power supplies, electronic card assemblies, sheet metal, cables, and connectors) and software, also known as computer programs.

Although computer systems were once stand-alone devices, computer systems today are increasingly connected via networks. One such network is the Internet or World Wide Web, in which electronic document transfer and message communication, such as electronic mail (e-mail), are commonplace. More and more users globally are communicating via e-mail, which is considerably less expensive and more convenient than telephone calls, faxes, or letters.

Often an e-mail message may contain other e-mail messages. For example, when the sender of a first e-mail is forwarding or replying to a second, original, e-mail, the first e-mail may include or contain the second e-mail. The first e-mail may contain the second e-mail embedded in the text of the first e-mail or as an attachment. Further, the second e-mail may contain a third forwarded or replied-to e-mail, and soon on. In this way, e-mails often contain multiple contained e-mail messages.

These multiple contained e-mails messages can quickly become overwhelming as the recipient attempts to determine the status of the contained-messages and process them. For example, as the recipients process messages, they must determine whether the contained-messages have been previously received and if the contained-messages have been modified (e.g., highlighted, annotated, or abridged). Then, the recipients may individually manage the contained-messages in their separately received form. For example, if the recipient decides to file the message, all of the contained-messages (as separately received) must be located and filed as well. This is a time consuming and error-prone process.

Further, often recipients will assume that they have seen the entire contained-message when in fact the contained-message is only an abridged version. Extreme examples include a user editing forwarded messages to intentionally alter their meaning. But more benign, yet still troublesome, examples include the sender removing information from forwarded messages that the sender simply thinks is unimportant, especially if the sender assumes that the recipient has already received the forwarded message from another source. Unfortunately, recipients may incorrectly assume that the forwarded message is complete, so they mistakenly believe that they have no need to view or process the original. But, what one person views as unimportant, another may view as vital.

Finally, when the recipient has received many messages from multiple senders all relating to the same topic, the recipient may inadvertently process a message that was not the contained one. For example, if a recipient has ten messages in an inbox that all have a subject of “project status,” some of which are also contained in other messages and some of which are not, it is easy to confuse them.

Without a better way for handling contained-messages, users will continue to suffer from confusion and lost time.

### SUMMARY

A method, apparatus, system, and signal-bearing medium are provided that, in an embodiment, provide status and commands for manipulating contained-messages. A received e-mail message may contain the contained-messages, e.g., forwarded or replied-to messages, either embedded in the received e-mail message or as an attachment. The status may relate to not only the contained-message, but also may relate to another version of the contained-message that was previously received separately from the e-mail message that contains the contained-message. Commands may be directed to the received e-mail and its contained-messages, the contained-messages, and the version of the contained-messages that were separately received.

### BRIEF DESCRIPTION OF THE DRAWING

FIG. 1 depicts a block diagram of an example system for implementing an embodiment of the invention.

FIG. 2 depicts a pictorial representation of an example user interface, according to an embodiment of the invention.

FIG. 3 depicts a block diagram of an example data structure for saved messages, according to an embodiment of the invention.

FIG. 4 depicts a flowchart of example processing for handling messages, according to an embodiment of the invention.

FIG. 5 depicts a flowchart of example processing for handling message commands, according to an embodiment of the invention.

### DETAILED DESCRIPTION

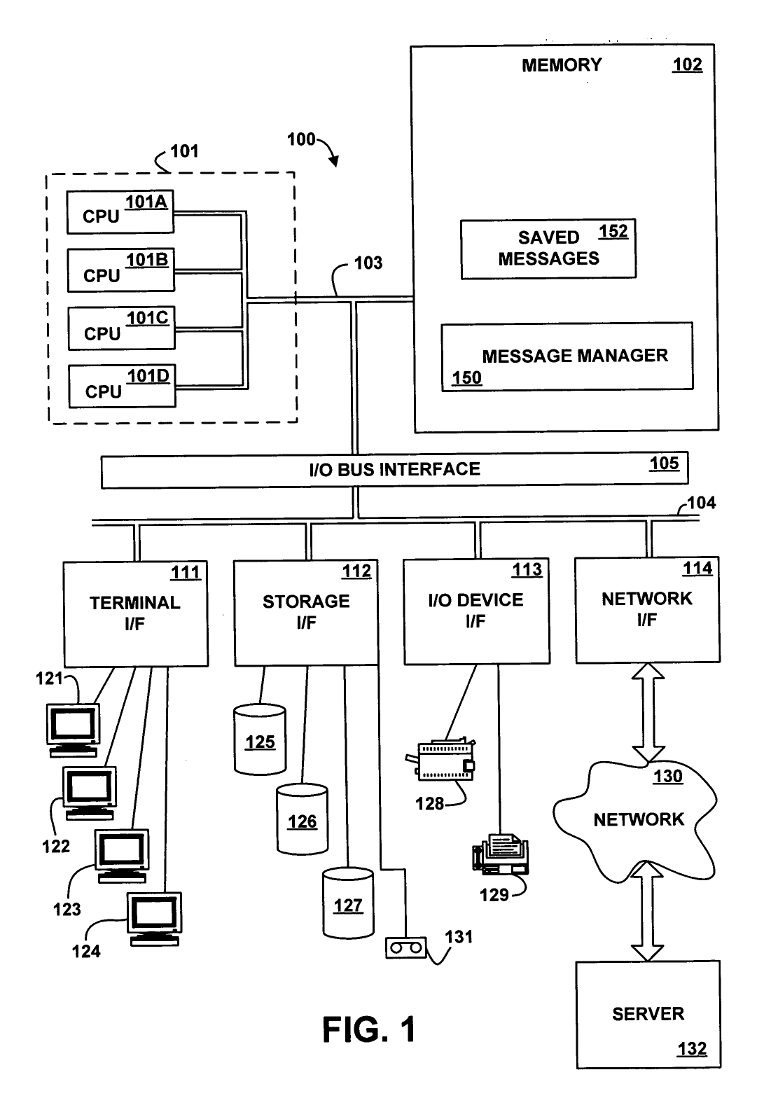

Referring to the Drawing, wherein like numbers denote like parts throughout the several views, FIG. 1 depicts a high-level block diagram representation of a computer system 100 connected to servers 132 via a network 130, according to an embodiment of the present invention. The major components of the computer system 100 include one or more processors 101, main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment, the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments, the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes a message manager 150 and saved messages 152. Although the message manager 150 and saved messages 152 are illustrated as being contained within the memory 102 in the computer system 100, in other embodiments, some or both of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the message manager 150 and saved messages 152 are both illustrated as being contained within the memory 102 in the computer system 100, they are not necessarily both completely contained in the same storage device at the same time.

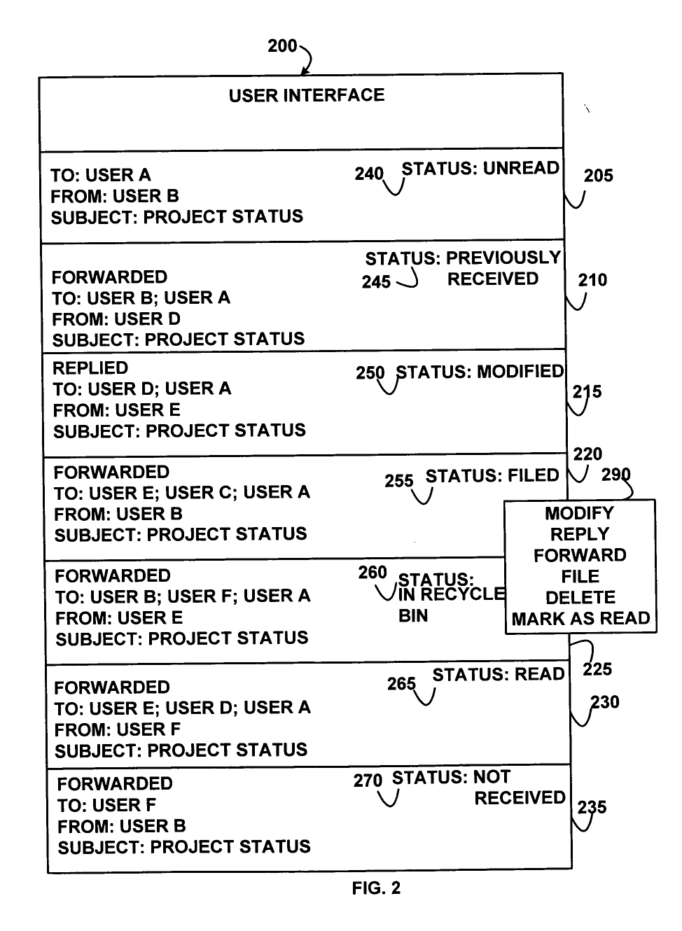

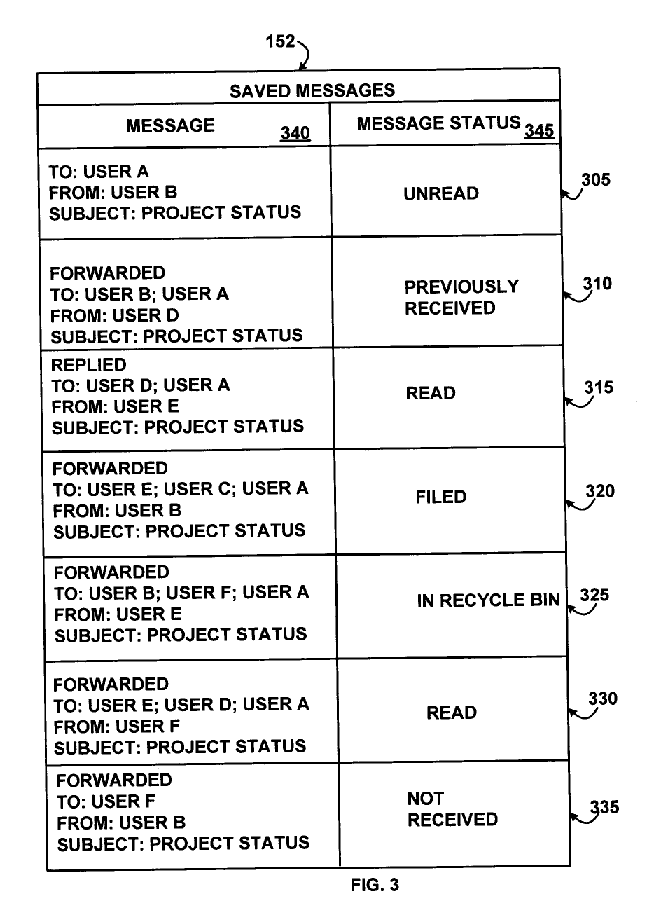

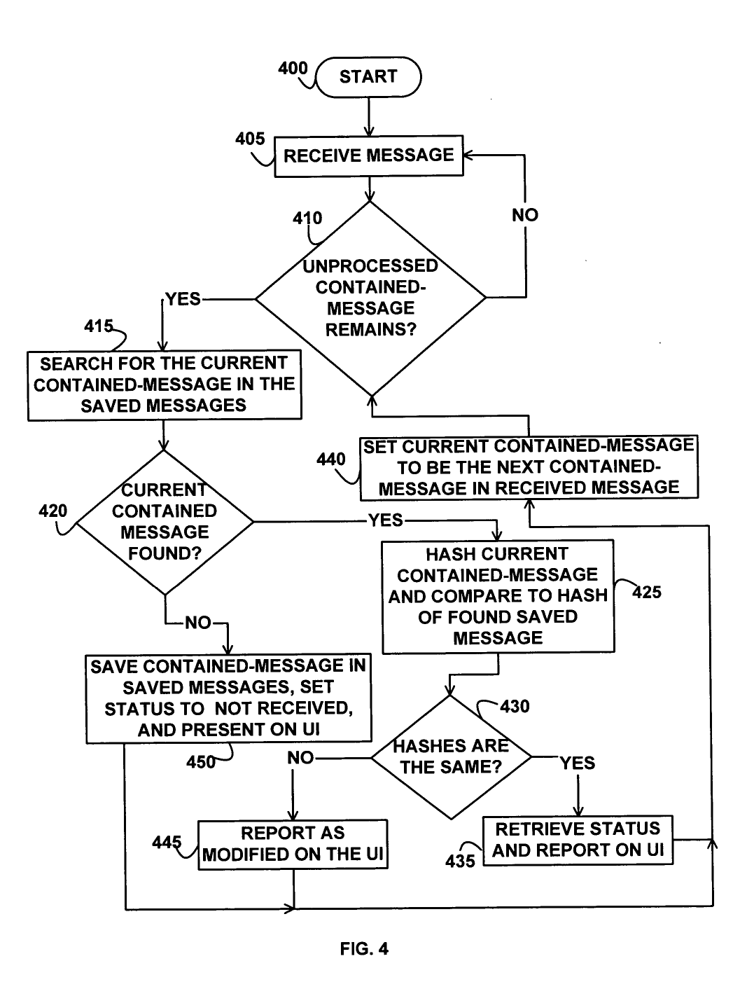

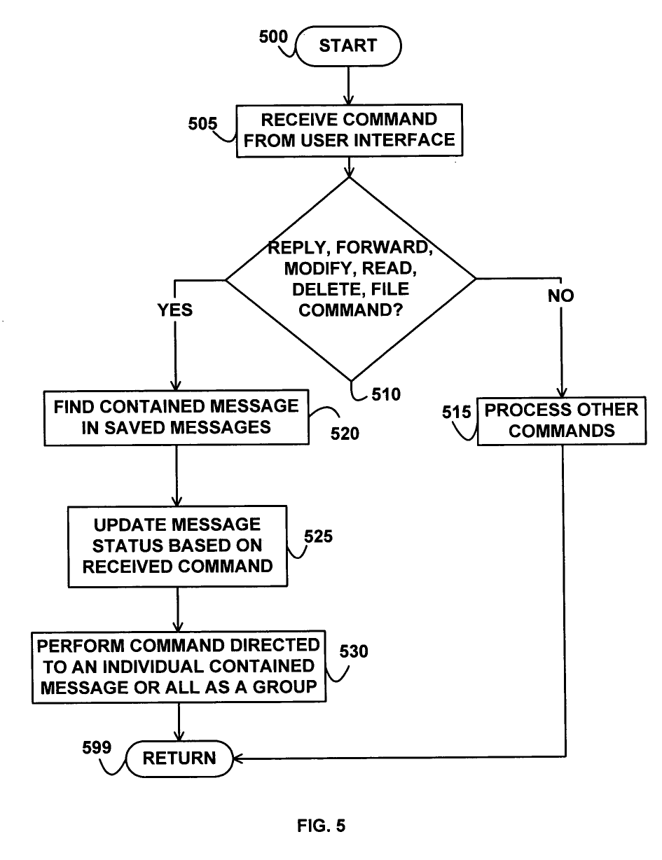

In an embodiment, the message manager 150 includes instructions capable of executing on the processor 101 or statements capable of being interpreted by instructions executing on the processor 101 to present the user interface as further described below with reference to FIG. 2, to manipulate the saved messages data structure 152 as further described below with reference to FIG. 3, and to perform the functions as further described below with reference to FIGS. 4 and 5. In another embodiment, the message manager 150 may be implemented in microcode. In yet another embodiment, the message manager 150 may be implemented in hardware via logic gates and/or other appropriate hardware techniques, in lieu of or in addition to a processor-based system.

The saved messages 152 are messages that have been received by the message manager 150 at the computer system 100. The saved messages 152 may be currently in the inbox of a user at the computer system 100, or they may be saved in a folder, library, or other container at the computer system 100 or any other appropriate remote location. The saved messages 152 are further described below with reference to FIG. 3.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O, bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be loaded from and stored to the memory 102 as needed. The storage interface unit 112 may also support other types of devices, such as a tape device 131, an optical device, or any other type of storage device.

The I/O and other device interface 113 provides an interface to any of various other input/output devices or devices of other types. Two such devices, the printer 128 and the fax machine 129, are shown in the exemplary embodiment of FIG. 1, but in other embodiments, many other such devices may exist, which may be of differing types.

The network interface 114 provides one or more communications paths from the computer system 100 to other digital devices and computer systems, e.g., the server 132; such paths may include, e.g., one or more networks 130. In various embodiments, the network interface 114 may be implemented via a modem, a LAN (Local Area Network) card, a virtual LAN card, or any other appropriate network interface or combination of network interfaces.

Although the memory bus 103 is shown in FIG. 1 as a relatively simple, single bus structure providing a direct communication path among the processors 101, the main memory 102, and the I/O bus interface 105, in fact, the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments, some or all of the I/O devices are connected directly to one or more system I/O buses.

The computer system 100, depicted in FIG. 1, has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a firewall, router, Internet Service Provider (ISP), personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In an embodiment, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line, cable, or bus. In another embodiment, the network 130 may support the Ethernet IEEE (Institute of Electrical and Electronics Engineers) 802.3x specification.

In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The server 132 may further include some or all of the hardware components previously described above for the computer system 100. Although only one server 132 is illustrated, in other embodiments any number of servers may be present.

It should be understood that FIG. 1 is intended to depict the representative major components of the computer system 100, the network 130, and the servers 132 at a high level, that individual components may have greater complexity than represented in FIG. 1, that components other than, fewer than, or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), CD-RW, or diskette; or

(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a pictorial representation of an example user interface 200, according to an embodiment of the invention. The example user interface 200 includes a received message 205. The received message 205 includes contained-messages 210, 215, 220, 225, 230, and 235. The received message 205 and the contained-messages 210, 215, 220, 225, 230, and 235 each include a status, such as the respective status 240, 245, 250, 255, 260, 265, and 270.

The status 240 indicates that the received message 205 has been received but has not been read by the user A. The status 245 indicates that the contained-message 210 was previously received, separate from the received message 205, by the user A. Thus, the status 245 is not merely a status of the contained-message 210, but also relates to, or is dependent on, the status of a previously received (separately received from the message 205) version of the contained-message 210.

The status 250 indicates that the contained-message 215 was modified prior to being sent to the user A as contained in the message 205. Thus, the status 250 is not merely a status of the contained-message 215, but also relates to, or is dependent on, the status of a previously received (separately received from the message 205) version of the contained-message 215.

The status 255 indicates that the contained-message 220 was previously received, separate from the message 205, and filed by the user A. The contained-message 220 in its previously received form may have been filed in the saved messages 150 or in any other appropriate data repository. Thus, the status 255 is not merely a status of the contained-message 220, but also relates to, or is dependent on, the status of a previously received (separately received from the message 205) version of the contained-message 220.

The status 260 indicates that the contained-message 225 was previously received, separate from the message 205, and deleted or sent to the recycle bin or trash can by the user A.

The status 265 indicates that the contained-message 230 was previously received, separate from the message 205, by the user A and read. Thus, the status 265 is not merely a status of the contained-message 230, but also relates to, or is dependent on, the status of a previously received (separately received from the message 205) version of the contained-message 230.

The status 270 indicates that the contained-message 235 has not been previously received, separate from the message 205, by the user A.

The various status 240, 245, 250, 255, 260, 265, and 270 are examples only, and in other embodiments, the status may indicate that the contained message is archived, partially received, sent (the contained message was previously sent by the user A), modified sent (the contained message was previously sent by the user A and then modified by the recipient before being forwarded or replied to the user A), or any other appropriate status.

The user interface 200 also includes a user interface 290, which includes commands that the user may request to be operated against any one or more of the messages 205, 210, 215, 220, 225, 230, 235, or against all of the messages as a group. The commands illustrated in the user interface 290 (modify, reply, forward, file, delete, and mark as read) are examples only, and in other embodiments any appropriate command may be used including, but not limited to, archive and mark as unread. The message manager 150 processes the commands requested via the user interface 290 as further described below with reference to FIG. 5.

FIG. 3 depicts a block diagram of an example data structure for the saved messages 152, according to an embodiment of the invention. The saved messages 152 includes records 305, 310, 315, 320, 325, 330, and 335, but in other embodiments any number of records with any appropriate data may be present. Each of the records includes a message field 340 and a message status field 345, but in other embodiments more or fewer fields may be present. The message field 340 includes e-mail messages that have been received by the message manager 150 and contained-messages that have not been received separately from the e-mail messages that contains them. The message status field 345 includes the status of the respective messages 340 and is updated by the message manager 150.

The record 305 includes a message status 345 of unread, indicating that the respective message 340 has been received, but has not been read by the user A. The record 310 includes a message status 345 of previously received, indicating that the respective message 340 was previously received by the user A. The record 315 includes a message status 345 of read, indicating that the respective message 340 has been previously read by the user A. The record 320 includes a message status 345 of filed, indicating the respective message 340 was previously received and filed by the user A. The record 325 includes a message status 345 of in recycle bin, indicating that the respective message 340 was previously received and deleted or sent to a recycle bin or trash can by the user A. The record 330 includes a message status 345 of read, indicating that the respective message 340 was previously received and read by the user A. The record 335 includes a message status 345 of not received, indicating that the respective message 340 has not been previously received, separate from the message 205, by the user A.

Although FIG. 3 illustrates the contained messages as being saved in independent records, in another embodiment the contained messages are saved as part of the original message, so the message status of previously received (record 310) and not received (record 335) are not used (and also not displayed in FIG. 2). The advantage is that existing e-mail systems may take advantage of this embodiment without needing to change the way they save messages.

FIG. 4 depicts a flowchart of example processing for handling received e-mail messages by the message manager 150, according to an embodiment of the invention. Control begins at block 400. Control then continues to block 405 where the message manager 150 receives a message via the network 130, e.g., from the server 132. Control then continues to block 410 where the message manager 150 determines whether a contained-message unprocessed by the logic of FIG. 4 remains in the message previously received at block 405. In various embodiments a contained-message is embedded in the received message as a forwarded message, a replied-to message, an attached message, or any other appropriate contained-message. If the determination at block 410 is false, then control returns to block 405, as previously described above.

If the determination at block 410 is true, then control continues to block 415 where the message manager 150 searches for the current contained-message in the saved messages, which were previously received by the message manager 150. Control then continues to block 420 where the message manager 150 determines whether the current contained-message in the received message was found in the saved messages 152. If the contained-message exists in the saved messages 152, then another version of the contained-message was previously received or sent separately from the message received at block 405, which contains the contained-message.

If the determination at block 420 is true, then the current contained-message was found in the saved messages 152, so control continues to block 425 where the message manager 150 performs a hash of the current contained-message and compares the results to a hash of the found message from the saved messages 152. In other embodiments, any appropriate technique may be used to compare the current contained-message to the found message in lieu of a hashing technique.

Control then continues to block 430 where the message manager 150 determines whether the results of the two hashes are the same. If the determination at block 430 is true, then the hashes are the same, so control continues to block 435 where the message manager 150 retrieves the message status 345 associated with the found message and presents it via the user interface 200. Thus, the message manager 150 presents status of the contained-message via the user interface 200, the contained-message is contained in another message (received at block 405), and the status is related to, or dependent on, a version of the contained-message that was received separately from the message that was received at block 405. Control then continues to block 440 where the message manager 150 sets the current contained-message to be the next contained-message in the received message, which was previously received at block 405. Control then returns to block 410, as previously described above.

If the determination at block 430 is false, then the hashes were not the same, so control continues to block 445 where the message manager 150 reports status via the user interface 200 that indicates the message was modified from a previous version of the message, where the previous version was received separately from the message (received at block 405) that contains the contained-message. For example, the contained-message 215 in the user interface 200 has been modified. Control then continues to block 440 where the message manager 150 sets the current contained-message to be the next contained-message in the received message, which was previously received at block 405. Control then returns to block 410, as previously described above.

If the determination at block 420 is false, then control continues to block 450 where the message manager 150 saves the current contained-message in a record in the saved messages 152, sets the message status 345 for the record to not received, and presents the status (e.g., the status 270) via the user interface 200 indicating that the contained-message has not been received (separately from the message previously received at block 405). Control then continues to block 440 where the message manager 150 sets the current contained-message to be the next contained-message in the received message, which was previously received at block 405. Control then returns to block 410, as previously described above.

FIG. 5 depicts a flowchart of example processing for handling message commands from the user interface 290 by the message manager 150, according to an embodiment of the invention. Control begins at block 500. Control then continues to block 505 where the message manager 150 receives a command from the user interface 290 (FIG. 2). Control then continues to block 510 where the message manager 150 determines whether the received command is a reply, forward, modify, read, delete, or file command. These commands may be directed to an individual contained-message, multiple contained-messages, or the message as a whole.

If the determination at block 510 is true, then the received command is a reply, forward, modify, read, delete, or file command, so control continues to block 520 where the message manager 150 finds the contained-message in the saved messages 152 to which the command is directed if the command is directed to an individual contained-message, or the message manager 150 finds all of the contained-messages in the saved messages 152 if the command is directed to the message as a whole. The message or messages found in the saved messages 152 are versions of the contained-message that were previously received separately from the message (e.g., the message 205) at block 405.

Control then continues to block 525 where the message manager 150 updates the message status 345 (FIG. 3) for the contained-message or messages to which the command is directed. Control then continues to block 530 where the message manager 150 performs the command directed to one, some, or all of the contained-messages. In an embodiment, the message manager 150 does not merely perform the command against the contained-message, but also performs the command against the version of the contained-message that was previously and separately received (found at block 520).

Using the example of FIG. 2, if the command is a file command directed to the message 205 as a whole, the message manager 150 files not only the message 205, but also the message manager 150 finds the versions of the contained-messages that were previously received separately from the message 205, and files them as well. Since the contained-messages 210, 215, and 230 were previously received separately and are not filed, the message manager 150 finds their previously received versions in the saved messages (at block 520) and files them (e.g., moves them from the in-box to a folder). If the file command is directed to only one or a subset of the contained-messages, the message manager 150 finds the separately-received contained-messages specified by the find command, and files them.

Analogously, again using the example if FIG. 2, if the command is a delete command directed to the message 205 as a whole, the message manager 150 deletes not only the message 205, but also the message manager 150 finds the versions of the contained-messages that were previously received separately from the message 205, and deletes them from the in-box as well.

Control then continues to block 599 where the logic of FIG. 5 returns.

If the determination at block 510 is false, then the received command is not a reply, forward, modify, read, delete, or file command, so control continues to block 515 where the message manager 150 process other commands. Control then continues to block 599 where the logic of FIG. 5 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized, and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
presenting status of at least one contained-message, wherein the at least one contained-message is contained in a message, and wherein the status is related to a version of the contained-message that was received separately from the message.

2. The method of claim 1, further comprising:
determining whether the contained-message is identical to the version of the contained-message that was received separately from the message.

3. The method of claim 2, wherein if the determining is false, the status comprises an indication that the contained-message is modified from the version of the contained-message that was received separately from the message.

4. The method of claim 1, wherein the status comprises an indication that the version of the contained-message that was received separately from the message has been filed.

5. An apparatus comprising:
means for determining whether a contained-message was previously received or sent separately from a message that contains the contained-message; and
means for presenting status of the contained-message.

6. The apparatus of claim 5, wherein the contained-message comprises a forwarded message.

7. The apparatus of claim 5, wherein the contained-message comprises a replied-to message.

8. The apparatus of claim 5, wherein the status indicates that the contained-message has not been previously received or sent if the means for determining is false.

9. A signal-bearing medium encoded with instructions, wherein the instructions when executed comprise:
receiving a command directed to a contained-message, wherein a message contains the contained-message;
finding a version of the contained-message that was previously separately received from the message; and
performing the command against the version of the contained-message that was previously separately received.

10. The signal-bearing medium of claim 9, further comprising:
presenting status of the contained-message, wherein the status is associated with the version of the contained-message that was previously received separately from the message.

11. The signal-bearing medium of claim 10, wherein the status comprises an indication that the version of the contained-message that was previously received separately from the message has been read.

12. The signal-bearing medium of claim 9, wherein the command comprises a file command.

13. A computer system comprising:
a processor; and
memory encoded with instructions, wherein the instructions when executed on the processor comprise:
receiving a command directed to a contained-message, wherein a message contains the contained-message,
finding a version of the contained-message that is separate from the message,
performing the command against the version of the contained-message that was previously received separately, and
presenting status of the contained-message, wherein the status is associated with the version of the contained-message that is separate from the message.

14. The computer system of claim 13, wherein the instructions further comprise:
updating the status based on the command.

15. The computer system of claim 13, wherein the version of the contained message that is separate from the message was previously sent separately from the message.

16. The computer system of claim 13, wherein the command is selected from a group consisting of a file command, a modify command, a reply command, a forward command, a delete command, a mark as read command, an archive command, and a mark as unread command.

17. A method for configuring a computer, comprising:
configuring the computer to present status of at least one contained-message, wherein the at least one contained-message is contained in a message, and wherein the status is related to a version of the contained-message that was received separately from the message.

18. The method of claim 17, further comprising:
configuring the computer to determine whether the contained-message is identical to the version of the contained-message that was received separately from the message.

19. The method of claim 18, wherein if the contained-message is not identical to the version of the contained-message that was received separately from the message, then the status comprises an indication that the contained-message is modified from the version of the contained-message that was received separately from the message.

20. The method of claim 17, wherein the status comprises an indication that the version of the contained-message that was received separately from the message has been filed.
